(19) United States
(12) Patent Application Publication
(10) Pub. No.: US 2002/0098311 A1
(43) Pub. Date: Jul. 25, 2002

(54) PROTECTIVE SHEATHING

(76) Inventor: MICHAEL LINDNER, ROSENHEIM (DE)

Correspondence Address: REED SMITH LLP, 375 PARK AVENUE, NEW YORK, NY, 10152, US

(21) Appl. No.: 09/388,752

(22) Filed: Sep. 2, 1999

(51) Int. Cl. B32B 9/00; B32B 33/00; G09F 3/00

(52) U.S. Cl. 428/40.1; 428/41.8; 428/43; 428/920; 428/921; 428/352; 428/188; 428/198; 428/220; 442/381; 442/391; 442/392; 442/402

(57) ABSTRACT

A protective sheathing is provided for use as a protective wrap about longitudinal objects such as cables, wires and bundles of wires in a wiring harness. The sheathing has at least two layers of a non-woven felt fabric. The two layers are bonded together at certain points between them, but not all points, with a hot melt net-like adhesive layer between the felt fabric layers. A layer of adhesive film or velcro is provided on an outside surface of one of the layers of non-woven felt fabric to secure the sheathing around the bundle of wires to be protected.

### FIELD OF THE INVENTION

The present invention relates generally to the field of coverings for protecting elongated objects, such as electrical wires, cables and bundles of wires or cables in order to protect the wires and cables from abrasion when such wires or cables are used in an environment where repeated contact with hard surfaces is likely to cause abrasion to the insulation of such wires or cables, which could result in the exposure of the bare metal core of the wires which carry electrical current. More particularly, the invention is directed to a composite structure for use as a protective sheathing material around wires and cables which are bundled together in a harness in vehicles, including automobiles, aircraft, water craft and in other equipment and machinery.

### BACKGROUND OF THE INVENTION

In automobiles, aircraft, water craft, other vehicles, and in a variety of electronic equipment or machinery, electrical wires and cables, which have an inner electrical current carrying metal core protected by an insulation, commonly formed of plasticized polymer materials, typically extend between various electrical components. Such wires and cables are usually bundled together in a harness, with each wire of the bundle connected between different electrical components. In an automobile for example, it is common practice to locate bundles of wires under the dash board, in the engine compartment, in the luggage compartment and in the floor and door way areas. All of these areas are subject to vibration during use of the automobile and it is likely that the wires from such bundles will come in contact with surrounding hard metal surfaces of the vehicle. Repeated contact with such metal surfaces tends to cause abrasion of the insulation around the metal cores of the wires creating a potential hazard by possibly exposing the metal core. Such exposure could lead to electrical short circuits disabling the electrical components connected by such wires or possibly leading to a fire. In addition, in vehicles such as in automobiles, aircraft, water craft, motorcycles and other vehicles, which during motion and operation tend to cause vibration, the wires and cables or the bundles of wires and cables which are located in various areas of the vehicles adjacent metal surfaces tend to come in frequent and repeated contact with the metal surfaces not only causing a risk of abrasion to the insulation on the wires and cables, but also resulting in undesirable rattling and vibration noises caused by the wires and cables slapping against the adjacent metal surfaces. Bundles of wires or cables which extend in an elongated fashion in vehicles, electronic equipment, plant machinery, farm machinery and many other types of equipment, commonly referred to as a wiring harness, because of the vibrations which frequently occur in such vehicles or machinery, the insulation or jackets surrounding the wires can be abraded or chafed by such vibration as a result of these wiring harnesses coming in contact with metal surfaces, metal edges or other sharp or hard surfaces. In order to avoid the possibility of such chaffing or abrasion as well as the rattling noise and vibration noises caused by the wiring harnesses coming in contact with adjacent surfaces, a variety of sheathing materials have been used as a wrapping around such wires or wiring harnesses, both in order to protect the wires or cables within such bundles from abrasion or chafing and to minimize or eliminate the rattling or vibration noises caused by the wiring harnesses repeated vibrational contact with adjacent metal surfaces. A variety of sheathing materials have heretofore been proposed for protecting the wiring harnesses by wrapping such material around the bundles of wires. Examples of such sheathing materials that have been used in the past include forms of plastic tape, commonly referred to as electrical tape, strips of polyurethane foam, which may or may not have a smooth polyurethane skin on its outside surface, and a variety of composite materials. Plastic or electrical tape and strips of polyurethane foam have been found to be inadequate to protect against the chafing and vibration noise caused by wiring harnesses or bundles of wires and cables rattling against metal surfaces. These materials have been found to rapidly abrade and expose the insulated wires of the bundles. Polyurethane foam material has also been found to be unacceptable because it does not adequately protect against abrasion and because in the case of fire it tends to produce cyanide gases which are highly toxic.

Another form of heretofore known protective sheathing material consists of a winding tape which has a two layer structure. The two layer structure includes two textile layers, one formed from non-woven fabric (sometimes referred to as “felt”) and the other made of a warp-knitted velour fabric. This form of two layer sheathing is referred to herein as a felt/velour composite. The two textile layers of the felt/velour composite are attached to each other by an adhesive, such as a hot melt or heat activated non-woven adhesive or film. Both textile layers are typically made of synthetic fibers, in particular polyamide or polyester, and the non-woven fabric can be a needle-punched non-woven. Other non-woven fabrics, including those in which the fibers are bonded by heat or by chemicals have also been used. The two layer felt/velour composite material is constructed in the form of a winding tape which, when used, is unwound from a reel and wrapped about a wire bundle to form a helical wrap about the bundle to be protected. The known felt/velour winding tapes usually range in width from about 1 cm to about 4 or 5 cm. Commercially available widths are 19 mm, 25 mm and 38 mm. The use instructions for the known felt/velour composite recommend helically winding it about the wire bundle with an angle to produce an overlap of adjacent windings of between 7 mm and 10 mm.

In the known felt/velour composite the layer of non-woven fabric is positioned on the inside surface of the winding so that when it is wrapped about the bundle the non-woven fabric will face and be adjacent to the wires of the bundles while the velour fabric is positioned on the outside surface of the wrap. As noted above, the two layer structure is wrapped about the bundle so that adjacent layers slightly overlap the turns around the bundle to be protected. The velour fabric is formed with hooks or loops which are raised. The raised loops are designed to be excessively high. An adhesive layer, such as the above noted non-woven adhesive, is positioned between the two textile layers in order to bond them together. An additional adhesive layer is provided on the exposed surface of the non-woven fabric so that the structure may adhere to the bundle of wires when it is wrapped about the bundle. The adhesive on the exposed surface of the non-woven layer is of the type such that when the two layer structure is formed in a reel, such as in the form of a winding tape to be unwound, this adhesive will come in contact with only the raised top edges of the loops of the velour fabric, a relatively small contact area and thus has a relatively low tension or bonding force. Accordingly, the bonding between the adhesive and the loops of the velour is only superficial so that the structure can easily be unwound from the reel for wrapping about the wire bundle.

The prior art sheathing materials have either been ineffective at preventing abrasion and/or eliminating the rattling noises, or have been excessively expensive due to the high cost of the materials and the manner in which they are helically wrapped about the wire bundle resulting in excessive waste. The larger the diameter of the bundle of wires the greater will be the amount of waste of the sheathing material that is required for helical wrapping about the bundle. While attempts have been made to wrap the aforementioned two layer felt/velour composite around the object to be protected in the form of a longitudinal tube, rather than a helical wrap in order to waste less material, it has been found that such a longitudinal tube does not adequately remain in place about a wire harness or wire bundle and has been found to be ineffective due primarily to the fact that the adhesive on the exposed surface of the non-woven layer will only adhere to the small surface area of the tops of the loops of the velour fabric and will not hold a tubular formation about longitudinal objects. In addition, the known felt/velour composites have been found to abrade or chafe resulting in exposure of the wires.

### OBJECTS OF THE INVENTION

It is accordingly a general object of the present invention to provide a protective sheathing composite material, for use as protection around elongated objects such as wires and cables, which overcomes the disadvantages of the prior art and is highly effective to prevent abrasion and provide sound deadening qualities when wrapped about such wires and cables.

It is another more specific object of the present invention to provide a protective sheathing material for use as a wrap about a wire or cable harness which is more cost effective than prior wrapping material because it can be successfully wrapped in a longitudinal tube rather than helically wrapped about such a bundle.

Yet a further particular object of the invention is to provide an embodiment of a protective sheathing for use as a protective wrap about longitudinal objects such as cables, wires and bundles of wires in a wiring harness, which is formed as a composite of at least two layers of non-woven fabric, with the facing surfaces of the layers of fabric bonded together at certain points between them but not at all points, and having a layer of adhesive on an outside surface of one of the layers of non-woven fabric so that the sheathing can be wrapped about the wires in a tubular position.

Another object of the invention is to provide an alternative embodiment of a protective sheathing in which a layer of velcro is provided on the outside surface of one of the layers of non-woven fabric so that when the sheathing is longitudinally wrapped about the wires in a tubular form, the velcro will interact and bond with the other surface of felt in order to securely hold the tubular configuration.

A further object of the present invention is to provide a protective sheathing of the foregoing type in which each of the layers of non-woven fabric is a needle punched felt fabric, the combination of which is highly effective at preventing abrasion and vibrational noises.

Other objects, features and advantages of the present invention will be apparent from the description hereinafter.

### BRIEF SUMMARY OF THE INVENTION

The invention is therefor directed to a protective sheathing for use as a protective wrap about longitudinal objects such as cables, wires and bundles of wires in a wiring harness which offers greater resistance to abrasion or chaffing and has superior sound deadening qualities than heretofore known in the art. This is achieved by providing a sheathing that has at least two layers of a non-woven felt fabric. The two layers are bonded together at certain points between them but preferably not at all points with a hot melt net-like adhesive layer between the felt fabric layers, which provides maximum flexibility. A layer of adhesive film or velcro is also provided on an outside surface of one of the layers of non-woven felt fabric to securely hold the sheathing around the bundle of wires to be protected.

The foregoing and other features of the present invention are more fully described with reference to the following drawings annexed hereto.

### BRIEF DESCRIPTION OF THE DRAWINGS

FIG. 1 is a perspective view of the cable sheathing according to one embodiment of the present invention;

FIG. 2 is a sectional view taken along lines II-II of FIG. 1;

FIG. 3 is a plan view of a net-like adhesive used in the present invention;

FIG. 4 is a plan view as viewed along arrow IV of FIG. 2;

FIG. 5 is a perspective view illustrating a bundle of wires helically wrapped with a sheathing in a conventional manner;

FIG. 6 is a perspective view of a bundle of wires protected by the sheathing of the present invention wrapped about said bundle in a tubular fashion;

FIG. 7 is a sectional view taken along lines VII-VII of FIG. 6;

FIG. 8 is a schematic perspective representation of another embodiment of the present invention;

14 FIG. 9 is a view similar to that of FIG. 8 illustrating yet a further embodiment; and

FIG. 10 is a view similar to that of FIG. 9 illustrating a variation of the embodiment shown in FIG. 9.

### DESCRIPTION OF THE PREFERRED EMBODIMENTS

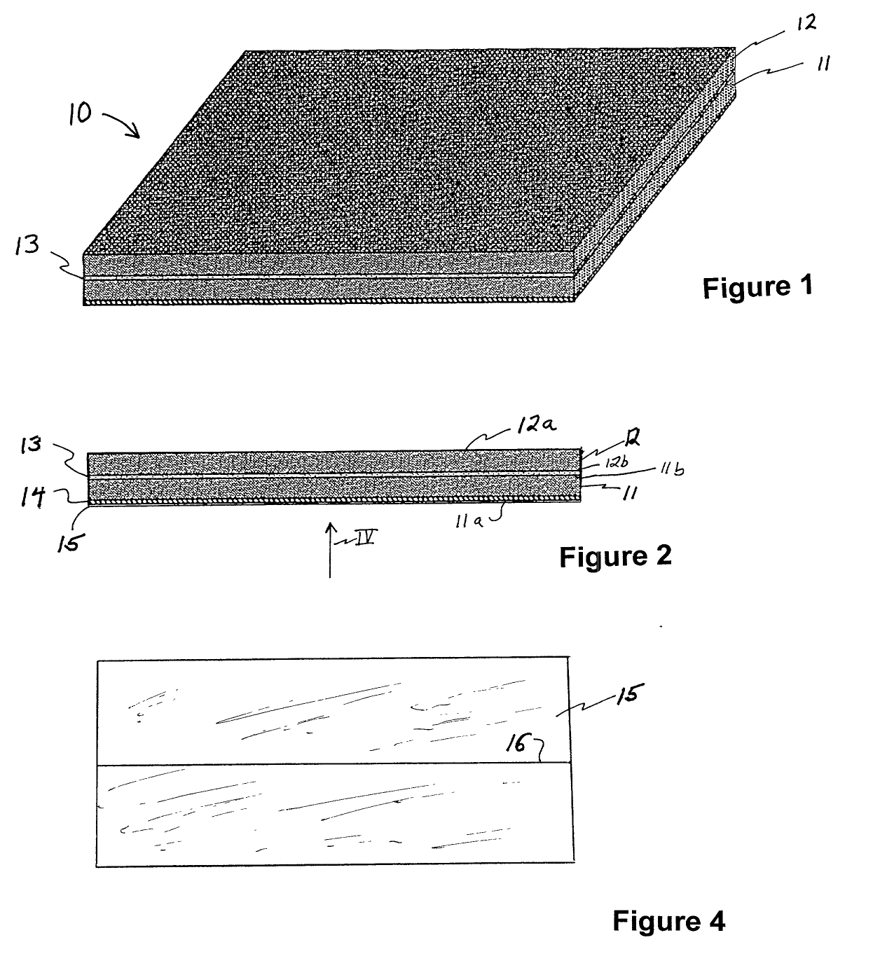

Referring now to the drawings, and with particular reference to FIGS. 1 and 2, reference numeral 10 denotes the sheathing according to the present invention. The sheathing includes first and second layers 11 and 12 respectively each of a non-woven, single fibre felt fabric for maximum flexibility. Each layer 11 and 12 has an outside surface 11a and 12a respectively and an inside surface 11b and 12b respectively. While more than two layers of non-woven felt fabric can also be used for greater abrasion resistance while maintaining flexibility, it has been found that at least two such layers are required to achieve the desired abrasion resistance capability. Non-woven fabrics are flexible porous fabrics which are not produced by traditional weaving or by loop formation. Non-woven fabrics are loose materials made of natural, synthetic, organic or mineral textile fibers held together by the interaction of these fibers. The individual fibers may either be unidirectional or randomly laid and may be held together (i) by applying heat to the fibers so that they bond at points of intersection; or (ii) by application of an adhesive or other chemical to the fibers so that they adhere together at points of intersection; or (iii) by needle punching the fibers. Needle punching is a process of repeated needling or punching needles through the fabric to mechanically hold them together. While most non-woven felts can be used in the invention, needle punch felts are preferred because they are traditionally more flexible than non-woven felt materials which have their fibers bonded by the application of heat, by some adhesive or by other chemical interaction. Non-woven fabrics have a typical pore structure with a large number of pores, a high fibre surface and a three dimensional structure. Needle punch non-woven felt materials which are particulary useful for the present invention can be made from a variety of fibrous materials such as polyester, viscose, polypropylene or rayon.

Such non-woven needle punch felt fabrics which have been found particulary suitable for the present invention are commercially available. The felt fabrics which have been found acceptable for the present invention can range in thickness from about 0.50 mm to about 2.00 mm, preferably 1.00 mm, and have a weight ranging from about 80 to 200 grams per square meter, preferably 120 to 150 grams per square meter. The felt fabrics used in the present invention may also be made with fibers hat have been treated so that they become fire retardant and will not degrade over a wide temperature range such as from about −40° C. to 120° C. In the automotive industry, the flame retardant standard is to prevent burning faster than 100 mm per minute. In addition, the needle punch felt fabric for use in the present invention can be made water or oil repellant by chemically treating the fibers or filaments with a water or oil repellant treatment. Treating the fibers prior to forming the fabrics, rather than treating the finished fabric itself to create fabrics with the desired flame retardant capability or water or oil repellency results in a more flexible fabric. Non-woven needle punch felts of the type described herein have been found to be ideally suited for the fabric layers 11 and 12.

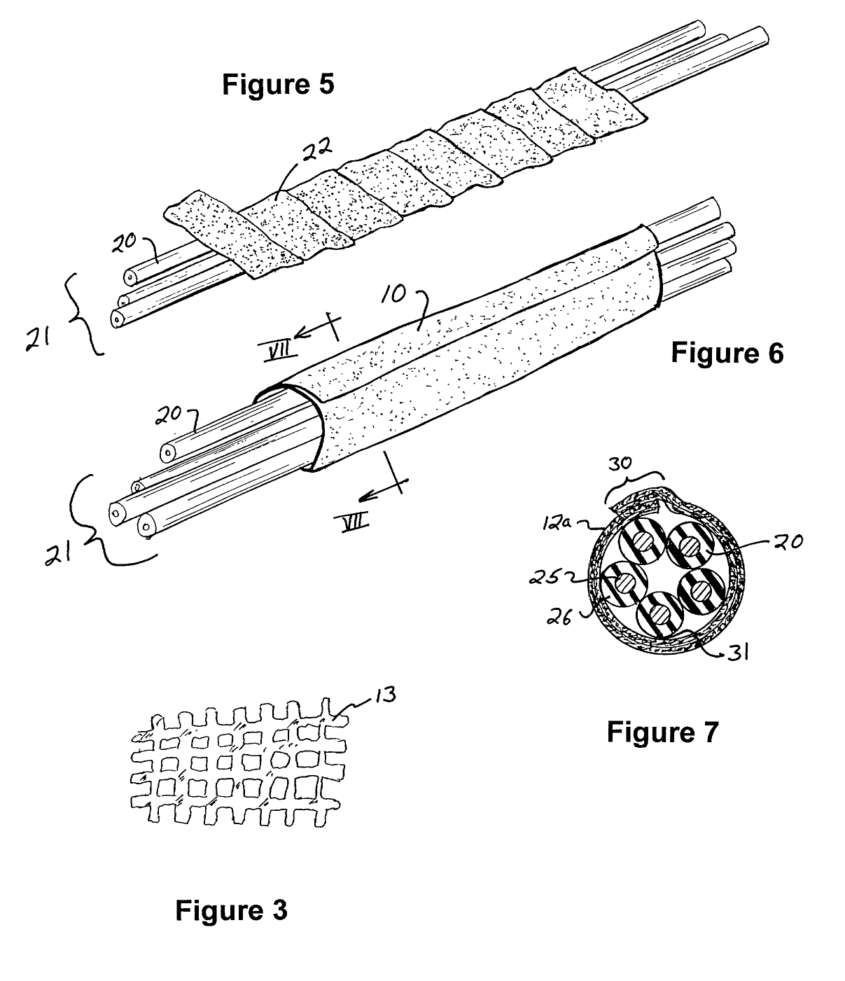

Fabric layers 11 and 12 are laminated or bonded together using an adhesive 13 applied between the inside surface 11b and 12b of fabric layers 11 and 12 respectively, so that inside surfaces 11b and 12b face each other. The overall thickness of the combined layers is therefore approximately 2.00 mm. A variety of adhesives and methods for applying the adhesive may be acceptable for the purposes of this invention. Preferably the adhesive is not applied to the entire surface of the laminated layers of fabric in order to maintain flexibility. Rather, it has been found desirable that areas between the two fabric layers remain free of adhesive. This can be achieved by using a perforated adhesive film which is layered between fabric layers 11 and 12, or by sprinkling or spraying dry adhesive, such as in a powder form onto only certain areas of the inside surfaces. In this manner a predetermined or random pattern of adhesive can be formed between the fabric layers without being applied to the entire inside surface. A hot melt type adhesive formed in a non-woven or net-like pattern, such as illustrated in FIG. 3, and which are commercially available, have been found to be particularly well suited for this invention. Net-like or non-woven adhesives usable in the invention have a weight of between 5 and 40 grams per square meter and are commercially available. Such a net-like non-woven hot melt adhesive also adds flexibility to the composite layered structure of the two layer fabric arrangement. Such a net-like or non-woven hot melt adhesive will preferably have a weight of approximately 10 to 20 grams per square meter and most preferably 14 grams per square meter. This will provide the required amount of bonding force between the layers 11 and 12 without adding unnecessary weight or rigidity to the composite structure. While a hot melt adhesive is a flammable substance, the low weight used in the invention will not materially impact its flame retardant capability.

In one embodiment of the invention adhesive layer 14 is provided on the outside surface 11a of needle punch felt layer 11. It is this adhesive layer 14 that is used for causing the composite two layer sheathing structure to adhere to and be securely held around the bundle of wires about which the composite structure 10 is to be wrapped for protection.

Adhesive layer 14 is preferably a film of acrylic or modified acrylic adhesive having a weight of between 60 to 120 grams per square meter, and in particular approximately 90 grams per square meter in order to provide the necessary adhesive strength required to maintain the composite structure in place about a harness or bundle of wires. A removable silicone release paper 15 is used to cover adhesive 14 prior to use so that when the sheathing composite structure 10 is wound into a reel the adhesive 14 will not bind to the outside surface 12a of layer 12, thus permitting easy unwinding when ready for use. Release paper 15 has a score line 16, shown in FIG. 4, for ease in separating the release paper 15 from the adhesive 14. The score line 16 will extend through release paper 15 so that when the composite structure 10 is manipulated the release paper 15 will separate at the score line so that it can be easily gripped for removal. Once the release paper 15 is removed, the exposed adhesive 14 will serve to secure the composite sheathing 10 to the bundle of wires to be protected.

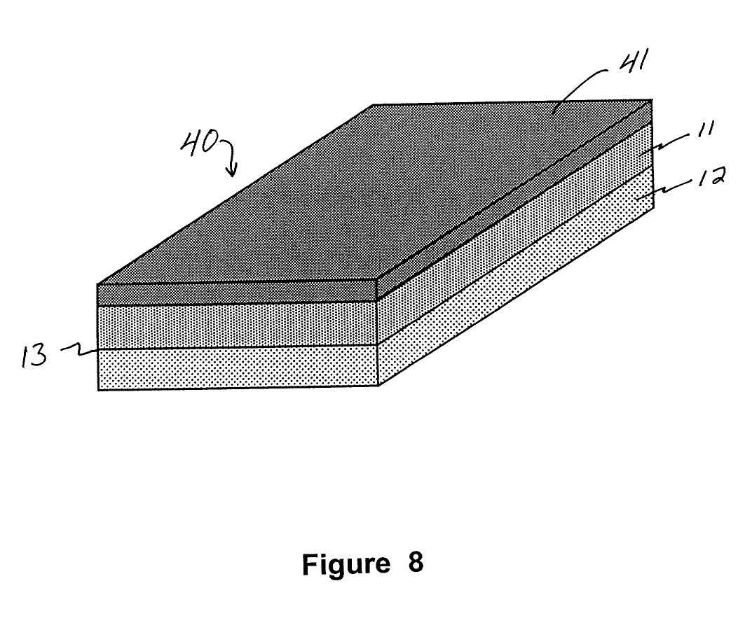

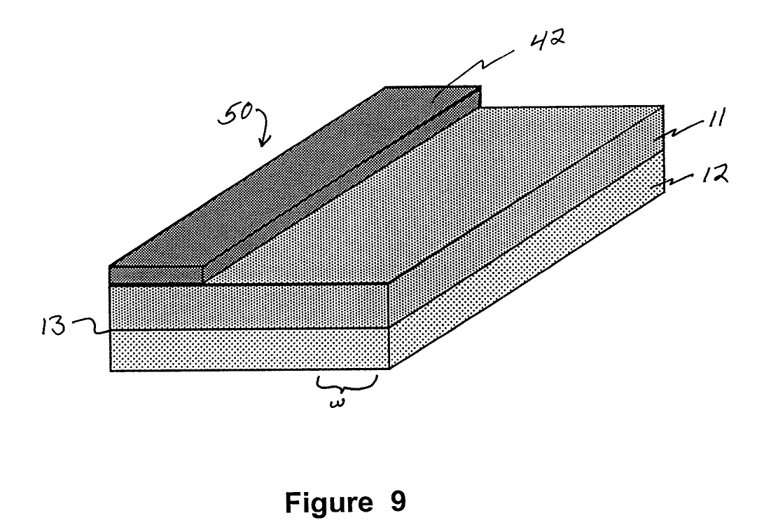

In the embodiment of the invention illustrated in FIG. 8, the protective sheathing 40 is formed in a manner similar to that described in connection with FIGS. 1 and 2 above having first and second layers 11 and 12, each of a non-woven felt fabric, preferably a needle punch felt fabric, laminated or bonded together by an adhesive 13 between the fabric layers 11 and 12. In this embodiment a layer of velcro 41 is provided on the outside surface of felt layer 11 instead of the adhesive layer 14 used in the embodiment described above in connection FIGS. 1 and 2. In this embodiment velcro layer 41 is of a well known commercially available type, typically formed of a plastic material such as polypropylene, and having a weight of between about 250 grams per square meter and 300 grams per square meter, and preferably about 270 grams per square meter, which has been found to produce good results. Velcro layer 41 is affixed or bonded to the outside surface of felt layer 11 by an appropriate adhesive. Alternatively, velcro layer 41 can be a double sided layer of velcro so that one side will adhere by mechanical interaction with the fibers of felt fabric layer 11. Accordingly, when the sheathing 40 is wrapped in a tubular form or fashion about an elongated object, such as wires or cables, a portion of the exposed surface of felt fabric layer 12 will overlap and come in contact with the exposed surface of velcro layer 41 (in a manner similar to that illustrated in FIG. 7). In this manner felt layer 12 will be mechanically bonded to the exposed surface of velcro layer 41 to provide a secure fit for the sheathing 40 about the wires or cables to be protected. Double sided, or sometimes referred to as back-to-back, velcro layers are also commercially available.

Because only a portion of the exposed surface of felt fabric layer 12 (a strip having a width of approximately 8 mm to 15 mm and most likely about 10 mm) will come in contact with the exposed surface of velcro layer 41 it is not necessary to cover the entire surface of felt fabric layer 11 with velcro layer 41. Rather, only a strip layer of between 8 and 15 mm wide velcro can be used. FIG. 9 illustrates an embodiment in which a sheathing structure 50 has a strip 42 of velcro adhered to only a portion of the exposed surface of fabric layer 11 along one edge thereof. In this embodiment, the sheathing 50 will be used in a manner similar to the embodiment described above to be wrapped around an elongated object to be protected, such as wires or cables in a tubular form. Thus, a strip “w” approximately 10 mm wide will come in contact with the exposed surface of velcro strip 42 in order to form a secure tubular wrap. In this embodiment, as in the embodiment shown in FIG. 8, velcro strip 42 can be bonded to a portion of the exposed surface of felt fabric layer 11 either by an adhesive or by using a back-to-back, or double sided velcro strip which will adhere to the felt layer 11 by mechanical interaction.

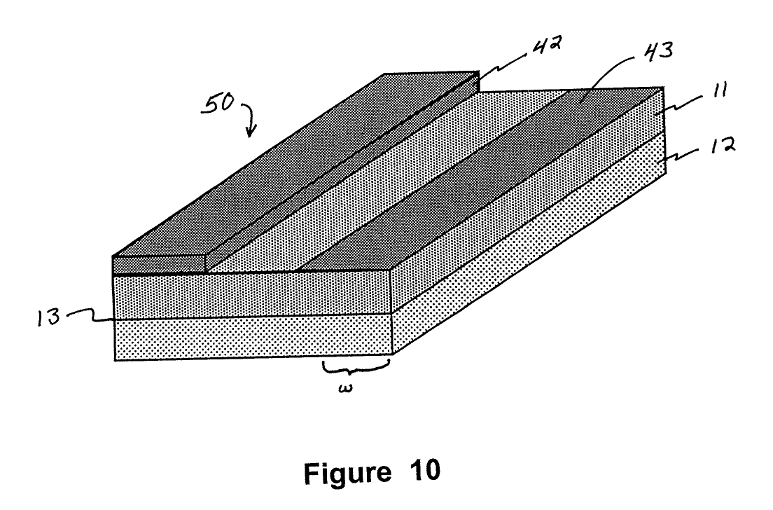

In FIG. 10, sheathing 50 can also be provided with a layer of adhesive 43. Adhesive 43 is applied to another portion of the exposed surface of felt fabric layer 11. Adhesive layer 43 can be of a type similar to adhesive layer 14 described above in connection with FIGS. 1 and 2. Adhesive layer 43 is used in this embodiment to come in contact with the objects to be protected, such as wires and cables, as a further means for securing sheathing 50 about these objects to provide a secure protective wrap. Thus, the embodiment illustrated in FIG. 10 will be used in a manner similar to that described in connection with FIG. 9 so that it may be wrapped in a tubular fashion about the elongated objects. A strip “w” of exposed surface of fabric layer 12 will thus come in contact with the exposed surface of velcro strip 42 to provide a secure contact with the mating surfaces while adhesive layer 43 comes in contact with the wires or cables about which the sheathing is wrapped.

It has been found that the two layer structure of the embodiments of the sheathing described above, of needle punch felts 11 and 12, provides unexpected and unusually effective abrasion resistance. The flexibility of the needle punch felt provides an effective cushion against repeated contact with hard surfaces. Testing reveals that such repeated contact tends to cause the needle punch felt to bunch into a bubble at the point of contact with surrounding surfaces. The creation of the bunched felt or bubble thus provides greater resistance to abrasion.

A particular advantage of the present invention is the ability to use this invention in a tubular wrap rather than a helical wrap as is required with the prior art sheathing materials. FIG. 5 illustrates the manner in which prior known protective material has traditionally been wrapped about cables or wires in order to protect them from abrasion. Wires 20, as shown in the figure, are typically bundled together to form a wire bundle 21. Known protective material 22 can be unwound from a reel, like a tape, and helically wrapped about the bundle 21 as illustrated in the figure. When so wrapped, a portion of each winding will overlap a portion of the previous winding. Depending upon the extent of overlap, a great amount of waste will be experienced in order to achieve a complete wrap of the bundle 21. Indeed, the larger the diameter of the bundle the larger the amount of waste. The prior known felt/velour composite material described above is recommended for use in the foregoing helically wrapped manner. So, for example, using the known felt/velour composite material from a reel having a width of 19 mm will require 1,300 mm of length (or 24,700 square mm) to cover a bundle of wires one meter long and 1.00 mm in diameter when wrapping the bundle in a helical manner with a recommended overlap of 7.00 to 10.00 mm. To helically wrap a one meter long bundle which is 3 mm in diameter will require 1,500 mm of 19 mm wide composite using the same 7.00 mm to 10.00 mm overlap, or 28,500 square millimeters. Using a wider tape will minimize the length of tape required, but the total amount of area of the composite material to cover the same length of bundle of wires will increase as the diameter increases, and hence the greater the amount of wasted overlapping material as illustrated in the following table:

AMOUNT OF MATERIAL REQUIRED TO COVER A ONE
METER LONG BUNDLE OF WIRES IN A HELICAL WRAP
WITH A 7.00 TO 10.00 mm OVERLAP

| | LENGTH REQUIRED | | |
|---|---|---|---|
| DIAMETER | 19 mm | 25 mm | 38 mm |
| OF BUNDLE | wide | wide | wide |
| 1 mm | 1300 | | |
| 2 mm | 1400 | | |
| 3 mm | 1500 | 1200 | |
| 4 mm | | 1350 | |
| 5 mm | | 1500 | |
| 6 mm | | 1600 | |
| 7 mm | | 1700 | |
| 8 mm | | 1800 | |
| 9 mm | | 1950 | |
| 10 mm | | 2100 | 1450 |
| 11 mm | | | 1600 |
| 12 mm | | | 1750 |
| 13 mm | | | 1850 |
| 14 mm | | | 1950 |
| 15 mm | | | 2050 |
| 16 mm | | | 2100 |
| 17 mm | | | 2200 |
| 18 mm | | | 2350 |
| 19 mm | | | 2450 |
| 20 mm | | | 2600 |
| 21 mm | | | 2850 |
| 22 mm | | | 3100 |
| 23 mm | | | 3350 |
| 24 mm | | | 3650 |
| 25 mm | | | 4000 |

FIG. 6 illustrates the use of the composite sheathing 10 of the present invention wrapped about a bundle of wires 21 in a tubular fashion. It will be appreciated that the sheathing 40 or 50 of the embodiments illustrated in FIGS. 8, 9 or 10 can also be used in the manner shown in FIG. 6. As best illustrated in FIG. 7 which is a cross-sectional view taken along lines VII-VII of FIG. 6, the composite protective sheathing 10 is wrapped about a bundle of wires 20. Each wire 20 is typically formed with an inner metal core 25 and an outer insulating area 26 usually formed of a polymer material. A small segment 30 will overlap so that outside surface 11a of layer 11 will lay over onto outside surface 12a of layer 12. Adhesive coating 14 will thus come in contact with the insulation of each wire 20 at a contact point 31 to secure the sheathing 10 about the bundle. In addition, adhesive 14 on the outside surface 11a of the layer 11, in the area of overlap 30, will adhere to the entire outside surface 12a to securely bond overlap 30 to the surface of layer 12. Thus, to protectively cover a bundle of wires one meter long will require a length of sheathing 10 which is also only one meter long and wide enough for adhesive 14 on overlap 30 to bond to surface 12a. An overlap of about 10.00 mm has been found acceptable to achieve good bonding. For example, using the present invention in a tubular wrap to cover a bundle having a diameter of 7.00 mm will require an amount of sheathing which is 1000 mm long and about 10.00 mm wider than the circumference of the bundle, or approximately 32 mm wide, for a total area of 32,000 square millimeters rather than 42,500 square millimeters of material if it were to be helically wrapped. Of course, while it may not be commercially feasible to supply the invention in every width, certain widths will likely be commercially available in order to minimize waste.

Thus, by using the present invention a significant amount of material and a significant amount of cost can be saved, because it can be used in a tubular wrap rather than a helical wrap.

The invention has been described and illustrated in connection with certain preferred embodiments which illustrate the principals of the invention. However, it should be understood that various modifications and changes may readily occur to those skilled in the art, and it is not intended to limit the invention to the construction and operation of the embodiment shown and described herein. Accordingly, additional modifications and equivalents may be considered as falling within the scope of the invention as defined by the claims herein below.

What is claimed is:

1. A protective sheathing for use as a protective wrap about longitudinal objects such as cables, wires and bundles of wires in a wiring harness, comprising first and second layers of non-woven fabric, each of said first and second layers having an inside surface and an outside surface, the inside surfaces of said first and second layers being bonded together, and means on the outside surface of said second layer of non-woven fabric for causing a portion of said second layer of non-woven fabric to adhere to an overlapping portion of the outside surface of said first layer when said sheathing is wrapped about said longitudinal objects.

2. The protective sheathing according to claim 1 wherein said outside surface of said second layer of non-woven fabric forms an inner surface of said sheathing, and the outside surface of said first layer of non-woven fabric forms an outer surface of said sheathing, a portion of said inner surface being in contact with a portion of said outer surface when said sheathing is wrapped longitudinally in a tubular form about said objects, and wherein said inside surfaces of said first and second layers are bonded together at certain points between them but not at all points.

3. The protective sheathing according to claim 2 wherein said inner surface faces said longitudinal objects for contact therewith.

4. The protective sheathing according to claim 3 wherein said first and second layers of non-woven fabric are bonded together by a non-woven net-like adhesive.

5. The protective sheathing according to claim 4 wherein said net-like adhesive is a hot melt adhesive.

6. The protective sheathing according to claim 5 wherein said first and second layers of non-woven fabric are identical non-woven felt fabric.

7. The protective sheathing according to claim 6 wherein said non-woven felt fabric is a needle punched felt fabric.

8. The protective sheathing according to claim 7 wherein said needle punched felt fabric has a weight ranging from about 80 grams per square meter to about 200 grams per square meter.

9. The protective sheathing according to claim 8 wherein said needle punch felt fabric has a weight ranging from 120 grams per square meter to 150 grams per square meter.

10. The protective sheathing according to claim 9 wherein said needle punch felt fabric is fire retardant.

11. The protective sheathing according to claim 9 wherein the fibers of said needle punch felt fabric are water repellant.

12. The protective sheathing according to claim 9 wherein the fibers of said needle punch felt fabric are oil repellant.

13. The protective sheathing according to claim 5 wherein said hot melt adhesive has a weight of between approximately 10 grams per square meter and approximately 20 grams per square meter.

14. The protective sheathing according to claim 13 wherein said hot melt adhesive has a weight of about 14 grams per square meter.

15. The protective sheathing according to claim 9 wherein said means on the outside surface of said second layer of non-woven fabric is a layer of adhesive.

16. The protective sheathing according to claim 15 wherein said adhesive layer on said outside surface of said second layer of non-woven fabric is an acrylic adhesive having a weight of approximately between 60 grams per square meter and 120 grams per square meter.

17. The protective sheathing according to claim 16 wherein said adhesive layer has a weight of approximately 90 grams per square meter.

18. The protective sheathing according to claim 17 further comprising a removable silicone release paper covering said adhesive layer on said outside surface of said second layer of non-woven fabric to prevent said adhesive layer from bonding to said outside surface of said first layer of non-woven fabric when said sheathing is wound into a reel prior to use.

19. The protective sheathing according to claim 18 wherein said release paper has a score line to facilitate separating said removable silicone release paper from said adhesive layer in order to expose said adhesive layer for use.

20. The protective sheathing according to claim 9 wherein said means on the outside surface of said second layer of non-woven fabric is a layer of velcro.

21. The protective sheathing according to claim 20 wherein said layer of velcro has a weight of approximately 270 grams per square meter.

22. The protective sheathing according to claim 20 wherein said layer of velcro is bonded to the outside surface of said second layer of non-woven fabric by an adhesive.

23. The protective sheathing according to claim 20 wherein said layer of velcro is a double sided layer of velcro and is bonded to said outside layer of non-woven fabric by mechanical interaction between said velcro and the fibers of said non-woven fabric.

24. The protective sheathing according to clam 20 wherein said layer of velcro is a strip having a width of between 8 mm and 15 mm.

25. The protective sheathing according to claim 24 wherein the width of said strip of velcro is approximately 10 mm.

26. The protective sheathing according to claim 25 further comprising a layer of adhesive on the outside of said second layer of non-woven fabric.

27. The protective sheathing according to claim 8 wherein the overall thickness of said protective sheathing is approximately 2.0 mm.

28. The protective sheathing according to claim 27 wherein the thickness of each of said first and second layers of non-woven fabric is approximately 1.0 mm.

29. The protective sheathing according to claim 6 wherein said non-woven fabric has fibers which are bonded together by application of heat.

30. The protective sheathing according to claim 6 wherein said non-woven fabric has fibers which are bonded together by chemical treatment.

31. The protective sheathing according to claim 6 wherein said non-woven fabric has fibers of polyester, viscose, polypropylene or rayon.

32. The protective sheathing according to claim 4 wherein said net-like adhesive is applied as an adhesive spray, or in dry adhesive form which is sprinkled onto said inside surfaces of said first and second layers of fabric.

33. The protective sheathing according to claim 5 wherein said hot melt adhesive is a thermo-plastic heat activated adhesive.

34. The protective sheathing according to claim 1 wherein said sheathing is stored in a wound up state in a reel or in a roll.

35. A method of using a protective sheathing according to claim 1 for protecting longitudinal objects which are subject to vibration in vehicles and machinery against abrasion and for reduction of noise by wrapping said sheathing about said objects.

36. The method of using a protective sheathing according to claim 35 wherein said sheathing is wrapped about said longitudinal objects longitudinally with an overlap of approximately 10.0 mm.

37. A protective sheathing comprising first and second layers of needle punched non-woven felt fabric, a hot melt adhesive between said first and second layers for bonding said first and second layers together at certain points but not at all points thereof, a layer of adhesive film on an outside surface of one of said first and second layers, and a removable silicone release paper covering said adhesive film when said protective sheathing is not in use for removal therefrom.

38. A protective sheathing comprising first and second layers of needle punched non-woven felt fabric, a hot melt adhesive between said first and second layers for bonding said first and second layers together at certain points but not at all points thereof, and a layer of velcro on an outside surface of one of said first and second layers.
